(19) United States
(12) Patent Application Publication
(10) Pub. No.: US 2007/0121728 A1
(43) Pub. Date: May 31, 2007

(54) Codec for IPTV

(75) Inventors: Xiaohong Wang, Beijing (CN); Yunchuan Wang, Beijing (CN); Michael Her, St. James, NY (US)

Correspondence Address: F. CHAU & ASSOCIATES, LLC, 130 WOODBURY ROAD, WOODBURY, NY, 11797, US

(73) Assignee: KylinTV, Inc.

(21) Appl. No.: 11/433,782

(22) Filed: May 12, 2006

Related U.S. Application Data
(60) Provisional application No. 60/680,331, filed on May 12, 2005.
(60) Provisional application No. 60/680,332, filed on May 12, 2005.

(51) Int. Cl. H04N 11/04

(52) U.S. Cl. 375/240.18

(57) ABSTRACT

A method of optimizing decoding of MPEG4 compliant coded signals is provided, comprising: disabling processing for non-main profile sections; performing reference frame padding; performing adaptive motion compensation. The method of decoding further including performing fast IDCT wherein an IDCT process is performed on profile signals but no IDCT is performed based on whether a 4×4 block may be all zero, or only DC transform coefficient is non-zero, and including CAVLC encoding of residual data. Reference frame padding comprises compensating for motion vectors extending beyond a reference frame by adding to at least the length and width of the reference frame. Adaptive motion compensation includes original block size compensation processing for chroma up to block sizes of 16×16.

This application claims priority to provisional applications Ser. Nos. 60/680,331, and 60/680,332, both filed on May 12, 2005. The disclosures of the provisional applications are incorporated by reference in their entirety herein.

### BACKGROUND

1. Technical Field

The present disclosure relates to a codec for encoding and decoding signals representing humanly perceptible video and audio; more particularly, a codec with speed optimization for use in Internet Protocol Television.

2. Discussion of Related Art

Video-on-demand or television program on demand have been made available to and utilized by satellite/cable television subscribers. Typically, subscribers can view at their television the video programs available for selection for a fee, and upon selection made at the subscriber's set-top-box (STB), the program is sent from the program center to the set-top-box via the cable or satellite network. The large bandwidth available at a cable or satellite network, typically at a capacity of 400 Mbps to 750 Mbps or higher, facilitates download of a large portion or the entire selected video program with very little delay. Some set-top-boxes are equipped with storage for storing the downloaded video and the subscriber watches the video program from the STB as if from a video cassette/disk player.

More recently, a selection of television programs are made available for viewing over the Internet using a browser and a media player at a personal computer. In some cases, the requested programs are streamed instead of downloaded to the personal computer for viewing. In these systems, the video programs are not viewed at a television through an STB. Nor is the viewing experience the same as watching from a video disk player because the PC does not respond to a remote control as does a television or a television STB. Even though media players on PCs can be controlled by a virtual on-screen controller, the control and viewing experience through a mouse or keyboard is different from a disk player and a remote control. Further, most PC users use their PCs on a desk in an actual or home office arrangement, which is not conducive to watching television programs or movies, e.g., the furniture may not be comfortable and the audiovisual effects cannot be as well appreciated. Moreover, if a PC accesses the Internet via a LAN and the access point is via DSL, the bandwidth capacity may be only 500 Kbps to 2 Mbps. This bandwidth limitation may render difficult a real-time, uninterrupted program streamed over the Internet unless the viewing area is made very small or very low resolution, or unless a highly compressed and speed optimized codec is used.

ITU-T H.264/MPEG-4 (Part 10) Advanced Video Coding (commonly referred as H.264/AVC) is an international video coding standard adopted by ITU-T's Video Coding Experts Group (VCEG) and ISO/IEC's Moving Picture Experts Group (MPEG). As has been the case with past standards, its design provides the most current balance between the coding efficiency, implementation complexity, and cost—based on state of VLSI design technology (CPU's, DSP's, ASIC's, FPGA's, etc.).

H.264/AVC is designed to cover a broad range of applications for video content including but not limited to, for example: Cable TV on optical networks, copper, etc.; Direct broadcast satellite video services; Digital subscriber line video services; Digital terrestrial television broadcasting; Interactive storage media (optical disks, etc.); Multimedia services over packet networks; and Real-time conversational services (videoconferencing, videophone, etc.), etc.

Three basic feature sets called profiles were established to address these application domains: the Baseline, Main, and Extended profiles. The Baseline profile was designed to minimize complexity and provide high robustness and flexibility for use over a broad range of network environments and conditions; the Main profile was designed with an emphasis on compression coding efficiency capability; and the Extended profile was designed to combine the robustness of the Baseline profile with a higher degree of coding efficiency and greater network robustness and to add enhanced modes useful for special “trick uses” for such applications as flexible video streaming.

While having a broad range of applications, the initial H.264/AVC standard (as it was completed in May of 2003), was primarily focused on “entertainment-quality” video, based on 8-bits/sample, and 4:2:0 chroma sampling. In July, 2004, a new amendment was added to this standard, called the Fidelity Range Extensions (FRExt, Amendment 1). The FRExt project produced a suite of four new profiles collectively called the High profiles.

The coding structure of this standard is similar to that of all prior major digital video standards (H.261, MPEG-1, MPEG-2/H.262, H.263 or MPEG-4 part 2). The architecture and the core building blocks of the encoder are also based on motion-compensated DCT-like transform coding. Each picture is compressed by partitioning it as one or more slices; each slice consists of macroblocks, which are blocks of 16×16 luma samples with corresponding chroma samples. However, each macroblock is also divided into sub-macroblock partitions for motion-compensated prediction. The prediction partitions can have seven different sizes—16×16, 16×8, 8×16, 8×8, 8×4, 4×8 and 4×4. In past standards, motion compensation used entire macroblocks or, in the case of newer designs, 16×16 or 8×8 partitions, so the larger variety of partition shapes provides enhanced prediction accuracy. The spatial transform for the residual data is then either 8×8 (a size supported only in FRExt) or 4×4. In past major standards, the transform block size has always been 8×8, so the 4×4 block size provides an enhanced specificity in locating residual difference signals. The block size used for the spatial transform is always either the same or smaller than the block size used for prediction.

As the video compression tools primarily work at or below the slice layer, bits associated with the slice layer and below are identified as Video Coding Layer (VCL) and bits associated with higher layers are identified as Network Abstraction Layer (NAL) data. VCL data and the highest levels of NAL data can be sent together as part of one single bitstream or can be sent separately. The NAL is designed to fit a variety of delivery frameworks (e.g., broadcast, wireless, storage media). Herein, we discuss the VCL, which is the heart of the compression capability.

The basic unit of the encoding or decoding process is the macroblock. In 4:2:0 chroma format, each macroblock consists of a 16×16 region of luma samples and two corresponding 8×8 chroma sample arrays. In a macroblock of 4:2:2 chroma format video, the chroma sample arrays are 8×16 in size; and in a macroblock of 4:4:4 chroma format video, they are 16×16 in size.

Slices in a picture are compressed by using the following coding tools:
“Intra” spatial (block based) prediction
   Full-macroblock luma or chroma prediction—4 modes (directions) for prediction
   8×8 (FRExt-only) or 4×4 luma prediction—9 modes (directions) for prediction
“Inter” temporal prediction—block based motion estimation and compensation
   Multiple reference pictures
   Reference B pictures
   Arbitrary referencing order
   Variable block sizes for motion compensation
      Seven block sizes: 16×16, 16×8, 8×16, 8×8, 8×4, 4×8 and 4×4
   ¼-sample luma interpolation (¼ or ⅛th-sample chroma interpolation)
   Weighted prediction
   Frame or Field based motion estimation for interlaced scanned video
Interlaced coding features
   Frame-field adaptation
      Picture Adaptive Frame Field (PicAFF)
      MacroBlock Adaptive Frame Field (MBAFF)
   Field scan
Lossless representation capability
   Intra PCM raw sample-value macroblocks
   Entropy-coded transform-bypass lossless macroblocks (FRExt-only)
8×8 (FRExt-only) or 4×4 integer inverse transform (conceptually similar to the well-known DCT)
Residual color transform for efficient RGB coding without conversion loss or bit expansion (FRExt-only)
Scalar quantization
Encoder-specified perceptually weighted quantization scaling matrices (FRExt-only)
Logarithmic control of quantization step size as a function of quantization control parameter
Deblocking filter (within the motion compensation loop)
Coefficient scanning
   Zig-Zag (Frame)
   Field
Lossless Entropy coding
   Universal Variable Length Coding (UVLC) using Exp-Golomb codes
   Context Adaptive VLC (CAVLC)
   Context-based Adaptive Binary Arithmetic Coding (CABAC)
Error Resilience Tools
   Flexible Macroblock Ordering (FMO)
   Arbitrary Slice Order (ASO)
   Redundant Slices
SP and SI synchronization pictures for streaming and other uses
Various color spaces supported (YCbCr of various types, YCgCo, RGB, etc.—especially in FRExt)
4:2:0, 4:2:2 (FRExt-only), and 4:4:4 (FRExt-only) color formats
Auxiliary pictures for alpha blending (FRExt-only)

Each slice need not use all of the above coding tools. Depending on the subset of coding tools used, a slice can be of I (Intra), P (Predicted), B (Bi-predicted), SP (Switching P) or SI (Switching I) type. A picture may contain different slice types, and pictures come in two basic types—reference and non-reference pictures. Reference pictures can be used as references for interframe prediction during the decoding of later pictures (in bitstream order) and non-reference pictures cannot. (It is noteworthy that, unlike in prior standards, pictures that use bi-prediction can be used as references just like pictures coded using I or P slices.)

This standard is designed to perform well for both progressive-scan and interlaced-scan video. In interlaced-scan video, a frame consists of two fields—each captured at ½ the frame duration apart in time. Because the fields are captured with significant time gap, the spatial correlation among adjacent lines of a frame is reduced in the parts of picture containing moving objects. Therefore, from coding efficiency point of view, a decision needs to be made whether to compress video as one single frame or as two separate fields. H.264/AVC allows that decision to be made either independently for each pair of vertically-adjacent macroblocks or independently for each entire frame. When the decisions are made at the macroblock-pair level, this is called MacroBlock Adaptive Frame-Field (MBAFF) coding and when the decisions are made at the frame level then this is called Picture-Adaptive Frame-Field (PicAFF) coding. Notice that in MBAFF, unlike in the MPEG-2 standard, the frame or field decision is made for the vertical macroblock-pair and not for each individual macroblock. This allows retaining a 16×16 size for each macroblock and the same size for all submacroblock partitions—regardless of whether the macroblock is processed in frame or field mode and regardless of whether the mode switching is at the picture level or the macroblock-pair level.

In addition to basic coding tools, the H.264/AVC standard enables sending extra supplemental information along with the compressed video data. This often takes a form called “supplemental enhancement information” (SEI) or “video usability information” (VUI) in the standard. SEI data is specified in a backward-compatible way, so that as new types of supplemental information are specified, they can even be used with profiles of the standard that had been previously specified before that definition.

The Baseline, Main, and Extended Profiles

H.264/AVC contains a rich set of video coding tools. Not all the coding tools are required for all the applications. For example, sophisticated error resilience tools are not important for the networks with very little data corruption or loss. Forcing every decoder to implement all the tools would make a decoder unnecessarily complex for some applications. Therefore, subsets of coding tools are defined; these subsets are called Profiles. A decoder may choose to implement only one subset (Profile) of tools, or choose to implement some or all profiles. The following three profiles were defined in the original standard, and remain unchanged in the latest version:
Baseline (BP)
Extended (XP)
Main (MP)

Table 1 gives a high-level summary of the coding tools included in these profiles. The Baseline profile includes I and P slices, some enhanced error resilience tools (FMO, ASO, and RS), and CAVLC. It does not contain B, SP and SI-slices, interlace coding tools or CABAC entropy coding. The Extended profile is a super-set of Baseline, adding B, SP and SI slices and interlace coding tools to the set of Baseline Profile coding tools and adding further error resilience support in the form of data partitioning (DP). It does not include CABAC. The Main profile includes I, P and B-slices, interlace coding tools, CAVLC and CABAC. It does not include enhanced error resilience tools (FMO, ASO, RS, and DP) or SP and SI-slices.

TABLE 1
Profiles in Original H.264/AVC Standard

| Coding Tools | Baseline | Main | Extended |
|---|---|---|---|
| I and P Slices | X | X | X |
| CAVLC | X | X | X |
| CABAC | | X | |
| B Slices | | X | X |
| Interlaced Coding (PicAFF, MBAFF) | | X | X |
| Enh. Error Resil. (FMO, ASO, RS) | X | | X |
| Further Enh. Error Resil. (DP) | | | X |
| SP and SI Slices | | | X |

The New High Profiles Defined in the FRExt Amendment

The FRExt amendment defines four new profiles:
High (HP)
High 10 (HiOP)
High 4:2:2 (Hi422P)
High 4:4:4 (Hi444P)

All four of these profiles build further upon the design of the prior Main profile, and they all include three enhancements of coding efficiency performance:
Adaptive macroblock-level switching between 8×8 and 4×4 transform block size
Encoder-specified perceptual-based quantization scaling matrices
Encoder-specified separate control of the quantization parameter for each chroma component

All of these profiles also support monochrome coded video sequences, in addition to typical 4:2:0 video. The difference in capability among these profiles is primarily in terms of supported sample bit depths and chroma formats. However, the High 4:4:4 profile additionally supports the residual color transform and predictive lossless coding features not found in any other profiles. The detailed capabilities of these profiles are shown in Table 2.

TABLE 2
New Profiles in the H.264/AVC FRExt Amendment

| | | | High | High |
|---|---|---|---|---|
| Coding Tools | High | High 10 | 4:2:2 | 4:4:4 |
| Main Profile Tools | X | X | X | X |
| 4:2:0 Chroma Format | X | X | X | X |
| 8 Bit Sample Bit Depth | X | X | X | X |
| 8 × 8 vs. 4 × 4 Transform Adaptivity | X | X | X | X |
| Quantization Scaling Matrices | X | X | X | X |
| Separate Cb and Cr QP control | X | X | X | X |
| Monochrome video format | X | X | X | X |
| 9 and 10 Bit Sample Bit Depth | | X | X | X |
| 4:2:2 Chroma Format | | | X | X |
| 11 and 12 Bit Sample Bit Depth | | | | X |
| 4:4:4 Chroma Format | | | | X |
| Residual Color Transform | | | | X |
| Predictive Lossless Coding | | | | X |

As shown in Table 3, H.264/AVC defines 16 different Levels, tied mainly to the picture size and frame rate. Levels also provide constraints on the number of reference pictures and the maximum compressed bit rate that can be used.

In the standard, Levels specify the maximum frame size in terms of only the total number of pixels/frame. Horizontal and Vertical maximum sizes are not specified except for constraints that horizontal and vertical sizes can not be more than Sqrt(maximum frame size*8). If, at a particular level, the picture size is less than the one in the table, then a correspondingly larger number of reference pictures (up to 16 frames) can be used for motion estimation and compensation. Similarly, instead of specifying a maximum frame rate at each level, a maximum sample (pixel) rate, in terms of macroblocks per second, is specified. Thus if the picture size is smaller than the typical pictures size in Table 3, then the frame rate can be higher than that in Table 3, all the way up to a maximum of 172 frames/sec.

TABLE 3
Levels in H.264/AVC

| | | | Maximum | Maximum |
|---|---|---|---|---|
| | | | compressed | number of |
| | | | bit rate (for | reference |
| | | | VCL) in | frames for |
| | Typical | Typical frame | non-FRExt | typical picture |
| Level Number | Picture Size | rate | profiles | size |
| 1 | QCIF | 15 | 64 kbps | 4 |
| 1b | QCIF | 15 | 128 kbps | 4 |
| 1.1 | CIF or QCIF | 7.5(CIF)/30(QCIF) | 192 kbps | 2(CIF)/9(QCIF) |
| 1.2 | CIF | 15 | 384 kbps | 6 |
| 1.3 | CIF | 30 | 768 kbps | 6 |
| 2 | CIF | 30 | 2 Mbps | 6 |
| 2.1 | HHR(480i or | 30/25 | 4 Mbps | 6 |
| | 576i) | | | |
| 2.2 | SD | 15 | 4 Mbps | 5 |
| 3 | SD | 30/25 | 10 Mbps | 5 |
| 3.1 | 1280 × 720p | 30 | 14 Mbps | 5 |
| 3.2 | 1280 × 720p | 60 | 20 Mbps | 4 |
| 4 | HD Formats | 60p/30i | 20 Mbps | 4 |
| | (720p or 1080i) | | | |
| 4.1 | HD Formats | 60p/30i | 50 Mbps | 4 |
| | (720p or 1080i) | | | |
| 4.2 | 1920 × 1080p | 60p | 50 Mbps | 4 |
| 5 | 2k × 1k | 72 | 135 Mbps | 5 |
| 5.1 | 2k × 1k or 4k × 2k | 120/30 | 240 Mbps | 5 |

A need therefore exists for a robust codec which is speed optimized to facilitate the coding and decoding of humanly perceptible video to provide real-time play of humanly perceptible video sent from a remote program center using Internet Protocol. There is also a need to optimize the codec processing so that the real-time play can be facilitated using a DSL connection at as low a bandwidth capacity of 500 Kbps.

### SUMMARY OF THE INVENTION

A method of optimizing decoding of MPEG4 compliant coded signals is provided, comprising: disabling processing for non-main profile sections; performing reference frame padding; performing adaptive motion compensation. The method of decoding further including performing fast IDCT wherein an IDCT process is performed on profile signals but no IDCT is performed based on whether a 4×4 block may be all zero, or only DC transform coefficient is non-zero, and including CAVLC encoding of residual data. Reference frame padding comprises compensating for motion vectors extending beyond a reference frame by adding to at least the length and width of the reference frame. Adaptive motion compensation includes original block size compensation processing for chroma up to block sizes of 16×16.

A method of encoding MPEG4 compliant data is also provided, comprising: performing Rate Distortion Optimization (RDO) algorithm, fast motion search algorithm, and bitrate control algorithm.

### BRIEF DESCRIPTION OF THE DRAWINGS

FIG. 1 shows motion segments used for reference.

FIG. 2 shows reference frame padding process according to an embodiment of the invention.

FIG. 3 shows Integer samples (shaded blocks with upper-case letters) and fractional sample positions (un-shaded blocks with lower-case letters) for quarter sample luma interpolations.

FIG. 4 shows Interpolation of chroma eighth-pel positions.

FIG. 5 shows current and neighbouring partitions in a motion compensation search process.

FIG. 6 shows a hexagon search.

FIG. 7 shows a full search for fractional pel search.

### DETAILED DESCRIPTION OF PREFERRED EMBODIMENTS

According to a preferred embodiment of the invention, platform-independent optimization of H.264 main profile decode is implemented. Decode process time can be shortened by optimization process including shutting down non-main profile sections, reference frame padding, adaptive block motion compensation, and Fast inverse DCT. Our study shows that a number of components, e.g., luma and chroma motion compensation and inverse integer transform, are the most time-consuming modules in the H.264 decoder. The speed of the optimized H.264 main profile decoder is about 2.0˜3.3 times faster compared with a reference decoder.

An MPEG4 compliant encoder and decoder, such as JM61e, is used as a reference codec. The reference decoder should be able to decode all syntactic elements and specified in the main profile. The PSNR (peak signal-to-noise ratio) value should also be maintained despite elimination of profiles.

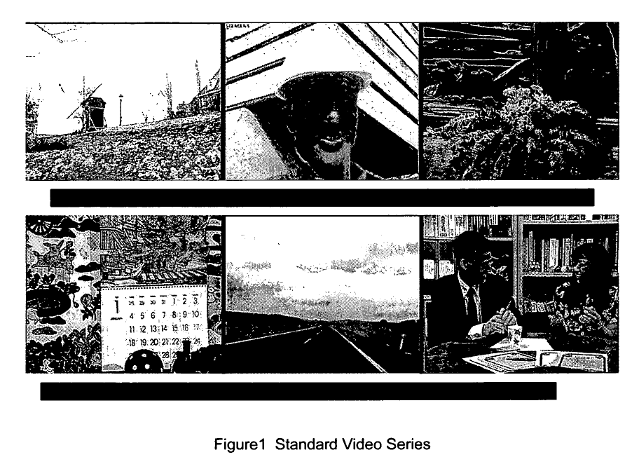

Six standard CIF video sequences are shown in FIG. 1 as the testing series. Within them flowergarden (a), tempete (c) and mobile (d) involve more movement. Foreman (b), highway (e) and paris (f) are more static.

Process elimination includes the following:
Since main profile decoder operates on only I, P and B slice types, all processes corresponding to SP and SI slices can be eliminated.
Preserve only one partition to place the input bitstream since the content of NAL unit in main profile does not contain coded slice partitions.
Delete error/loss robustness features, including FMO (Flexible Macroblock Ordering), ASO (Arbitrary Slice Ordering), and RS (Redundant Slices).
Delete unused variables and functions.

Two encoded bitstreams are tested, having specifications of CIF size, one reference frame, one slice per frame, only first is I frame, quantization parameter is 28, max search range is 16, RD-Optimization and Hadamard transform, and block types from 16×16 to 4×4 are used. The Foreman video bitstream has maximum compression ratio (300 frames) for the above configuration. The garden bitstream has minimum compression ratio (250 frames). The encoding performance of these two sequences is listed in the first four columns of Table 1.

To further optimize the main profile decoder, areas of decoding bottleneck are identified, and the most time consuming modules are simplified, using the following parameters:
single frame reference (NumberReferenceFrames=1);
one slice in each frame (SliceMode=0);
I frame interval is 100 (IntraPeriod=100);
quantization parameter is 25 (QPFirstFrame=QPRemainingFrame=25);
not using Hadamard (UseHadamard=0);
max search range is 16 (SearchRange=16);
not using rate distortion optimization (RDOptimization=0);
using all blocks types from 16×16 to 4×4 (InterSearchl16×16=1, InterSearchl16×8=1, InterSearch8×16=1, InterSearch8×8=1, InterSearch8×4=1, InterSearch4×8=0, InterSearch4×4=1);
Inter pixels are used for Intra macroblock prediction (UseConstrainedlntraPred=0);
POC mode is 0 (PicOrderCntType=0).

Entropy coding method is 0, i.e. CAVLC (SymbolMode=0)

TABLE 3
Encoding results of six standard series with same config file

| | | | | | bitrate | |
|---|---|---|---|---|---|---|
| | | | | | (Kbits/s) | |
| | Encoded | SNR | SNR | SNR | (framerate is | Encoding |
| sequence | frames | Y | U | V | 30) | time (s) |
| flowergarden | 250 | 37.23 | 39.06 | 39.45 | 2618.73 | 200.982 |
| foreman | 300 | 38.11 | 41.80 | 43.70 | 846.02 | 242.078 |
| tempete | 260 | 37.02 | 38.79 | 40.12 | 2219.72 | 208.350 |
| mobile | 300 | 36.29 | 37.80 | 37.72 | 2905.49 | 238.251 |
| highway | 300 | 39.60 | 39.23 | 39.92 | 621.51 | 245.699 |
| paris | 300 | 37.85 | 40.82 | 40.97 | 785.39 | 228.793 |

Using the above configuration, the encoding result of the six series is displayed in Table 3. It can be seen from table 3 that the quality (SNR) and bitrate of reconstructed series varies according to the content of each series. In general, objective quality of reconstructed slow moving series is much better than fast moving series, and bitrate of slow moving is much slower.

TABLE 4
Time profile for non-optimized main profile decoder

| | | | | | Buffer | | |
|---|---|---|---|---|---|---|---|
| | Motion | | | Entropy | management | Decoding | decoding |
| sequence | Compensation | IDCT | Deblock | decoding | and others | time(s) | framerate |
| flowergarden | 24.8% | 5.0% | 4.4% | 58.0% | 7.8% | 11.375 | 21.978 |
| foreman | 42.4% | 7.0% | 6.2% | 33.8% | 10.6% | 9.687 | 30.969 |
| tempete | 30.1% | 5.0% | 5.1% | 53.0% | 6.8% | 12.156 | 21.389 |
| mobile | 25.3% | 4.2% | 4.5% | 59.9% | 6.1% | 16.125 | 18.605 |
| highway | 38.6% | 9.0% | 6.0% | 35.1% | 11.3% | 7.640 | 39.267 |
| paris | 34.6% | 9.3% | 5.8% | 35.8% | 14.5% | 7.062 | 42.481 |

Major function modules of main profile H.264 decoder are time-profiled in table 4. Result of these tests have been achieved on a PC Pentium □ processor, running at 2.4 GHz, equipped with 512 Mbytes of memory, with Windows 2000 professional. For each sequence tests are done 10 times and averaged to minimize the non-deterministic effects of processor cache, process scheduler, and operative system management operations.

From table 4, it can be seen that the following modules are the key kernels in the decoder: luminance and chrominance motion compensation, entropy decoding, inverse integer transform, and deblocking filtering, among which motion compensation and entropy decoding are the most time-consuming modules. Unlike many previous video coding standards, chrominance motion compensation occupies a significant percentage in the total motion compensation process of the H.264 standard. Entropy decoding time is proportional to the bitrate of bitstream. By improving the processing speed of these most time-consuming modules, the efficiency of the decoder is improved.

According to a preferred embodiment of the present invention, further processes are implemented to improve on decoding processing speed. The processes include reference frame padding and adaptive block motion compensation MC. Inverse DCT transform is optimized by judging its dimension. Residual data CAVLC decoding tables are reformed for faster speed. As will be further detailed below, these processes improved the speed of the optimized H.264 main profile decoder about seven times faster compared with the reference decoder.

H.264 standard allows motion vectors to point over picture boundaries. When computing inter prediction for a P-macroblock, the pixel position used in reference frame may exceed frame height and width. In this case, the nearest pixel value in reference frame is used for computation. In reference code, whenever a pixel (x_pos, y_pos) in reference frame is used for motion compensation, really used position (x_real, y_real) is obtained by the following equation:
y_real=max(0,Min(img_height−1,y_pos))
x_real=max(0,min(img_widtht−1,x_pos))
To avoid the above computation, alternative frame padding is employed:

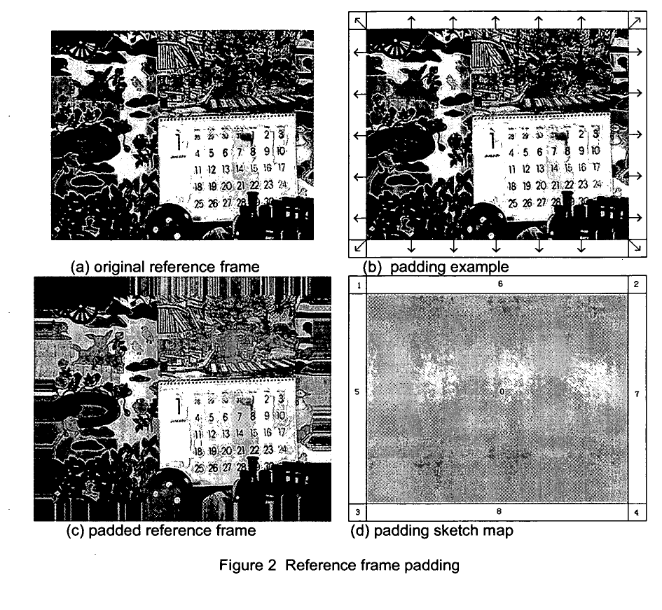

The padding is added on top, bottom, left and right of the reference frame as shown in FIG. 2a to 2d. Suppose frame height is img_height, and frame width is img_width, then padded reference frame height is img_height+2*Y_PADSTRIDE, and padded reference frame width is img_width+2*Y_PADSTRIDE. Y_PADSTRIDE can be determined by (max (mv_x, mv_y)+8. If search range is 16 and motion is slow, Y_PADSTRIDE can be equal to 24. For heavier motion sequence, larger value for Y_PADSTRIDE should be set.
The padding process is as follows (see FIG. 2(d)):
Region0: corresponding values in original frame
Region1: all samples equal to up-left corner pixel in original frame:
Region2: all samples equal to up-right corner pixel in original frame
Region3: all samples equal to down-left corner pixel in original frame
Region4: all samples equal to down-right corner pixel in original frame
Region5: extrapolated horizontally by first column pixel in original frame
Region6: extrapolated vertically by first row pixel in original frame
Region7: extrapolated horizontally by last column pixel in original frame
Region8: extrapolated vertically by last row pixel in original frame

Y, U and V components are padded using the same technique. The only difference is that the padding stride for U and V component is half as that of Y component. It should be noted that the side effect of the above reference frame padding process can be increased memory requirements and extra time for padding.

Adaptive Block MC

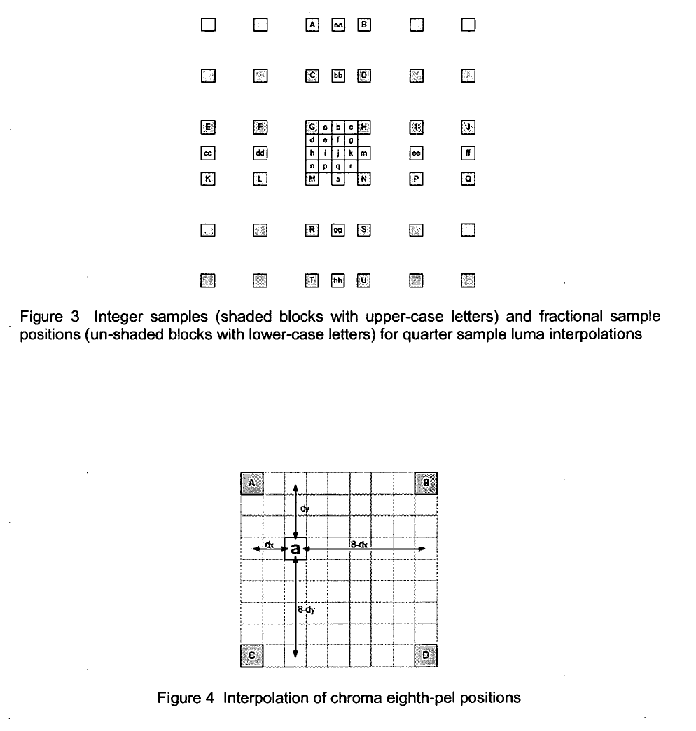

In the reference codec, luma compensation is computed by 4×4 block. But real motion compensation blocks are 16×16, 8×16, 16×8, 8×8, 4×8, 8×4, and 4×4. Suppose a macroblock is predicted by 16×16 mode, reference software will call 4×4 motion compensation function 16 times. If the predicted position is half-pixel or quarterl-pixel position, the computation time used by calling 4×4 block MC 16 times is definitely more than direct 16×16 block MC because of functions invocation cost and data cache. Especially for positions j, i, k, f, and q depicted in FIG. 3, computation is lessen by using larger block MC because of the characteristic of 6-tap filter. On the other hand, large block types (16×16, 8×16, 16×8) are used more frequently compared with smaller block types. It has been reported that the total number of 4×4, 4×8 and 8×4 blocks used in motion estimation takes up about 5% in P-frames among different block sizes. Therefore, adaptive block MC can be employed, e.g., using MxN size interpolation directly for M×N block type (M and N may be 16, 8 or 4) instead of using only 4×4 size interpolation.

In the reference codec, chroma motion compensation is computed point by point. In this way, dx, dy, 8-dx, 8-dy, and the positions of A, B, C, D showed in FIG. 4 are calculated for each chroma point. Real chroma motion compensation blocks should be half of luma prediction block (8×8, 4×8, 8×4, 4×4, 2×4, 4×2, and 2×2). Hence computing chroma MC on it original block base is more computational efficient.

Fast IDCT

Instead of using conventional DCT/IDCT, H.264 standard uses a 4×4 integer transform to convert spatial-domain signals into frequency-domain and vice versa. Two-dimensional IDCT is implemented in the reference code, and each 4×4 block of transformed coefficients is inverse transformed by calling this 2D IDCT transform. In fact, transform coefficients in a 4×4 block may be all zero, or only DC transform coefficient is non-zero. Thus, a decision can be made before IDCT is performed. The decision is based on the syntax_element coded_block_pattern (cbp). Coded_block_pattern specifies which of the six 8×8 blocks—luma and chroma—contain non-zero transform coefficient levels. For macroblocks with prediction mode not equal to Intra_{—}16×16, coded_block_pattern is present in the bitstream and the variables CodedBlockPatternLuma and CodedBlockPatternChroma are derived as follows.
CodedBlockPatternLuma=coded_block_pattern % 16
CodedBlockPatternChroma=coded_block_pattern/16

The judgment for luma 4×4 block is as follows:

| | |
|---|---|
| if (currMB->cbp & (1<<block8×8)) | Dimension = 2; |
| else if (img->cof[i][j][0][0] != 0) | Dimension = 1; |
| else | Dimension = 0; |

The judgment for chroma 4×4 block is as follows:

| | |
|---|---|
| if (currMB->cbp>31) | Dimension = 2; |
| else if (img->cof[2*uv+i][j][0][0] != 0) | Dimension = 1; |
| else | Dimension = 0; |

2.4 Fast CAVLC Decoding Algorithm

From table 4 and table 5 one can see that entropy decoding module is very time consuming (up to 60%) for high bitrate sequence. Parameters that require to be transmitted and decoded are displayed in Table 6. Among them residual data is most time consuming and processing speed improvement can be made by optimizing this data processing.

TABLE 6
Parameters to be encoded

| Parameters | Description |
|---|---|
| Sequence-, picture- | |
| and slice-layer | |
| syntax elements | |
| Macroblock type | Prediction method for each coded |
| mb_type | macroblock |
| Coded block pattern | Indicates which blocks within a macroblock |
| | contain coded coefficients |
| Quantizer parameter | Transmitted as a delta value from the |
| | previous value of QP |
| Reference frame index | Identify reference frame(s) for inter |
| | prediction |
| Motion vector | Transmitted as a difference (mvd) from |
| | predicted motion vector |
| Residual data | Coefficient data for each 4 × 4 or 2 × 2 block |

Above the slice layer, syntax elements are encoded as fixed- or variable-length binary codes. At the slice layer and below, elements are coded using either Context-based adaptive variable length coding (CAVLC) or context adaptive arithmetic coding (CABAC) depending on the entropy encoding mode.

CAVLC is the method used to encode residual, zig-zag ordered 4×4 (and 2×2) blocks of transform coefficients. CAVLC is designed to take advantage of several characteristics of quantized 4×4 blocks:
After prediction, transformation and quantization, blocks are typically sparse (containing mostly zeros). CAVLC uses run-level coding to compactly represent strings of zeros.
The highest non-zero coefficients after the zig-zag scan are often sequences of +/−1. CAVLC signals the number of high-frequency +/−1 coefficients (“Trailing 1s” or “T1s”) in a compact way.
The number of non-zero coefficients in neighbouring blocks is correlated. The number of coefficients is encoded using a look-up table; the choice of look-up table depends on the number of non-zero coefficients in neighbouring blocks.
The level (magnitude) of non-zero coefficients tends to be higher at the start of the reordered array (near the DC coefficient) and lower towards the higher frequencies. CAVLC takes advantage of this by adapting the choice of VLC look-up table for the “level” parameter depending on recently-coded level magnitudes.

By CAVLC encoding of a block of transform coefficients, the bottleneck of entropy decoding can be simplified. CAVLC encoding of residual data proceeds as follows.

Step 1: Encode the Number of Coefficients and Trailing Ones (Coeff_token).

The first VLC, coeff_token, encodes both the total number of non-zero coefficients (TotalCoeffs) and the number of trailing +/−1 values (T1). TotalCoeffs can be anything from 0 (no coefficients in the 4×4 block) to 16 (16 non-zero coefficients). T1 can be anything from 0 to 3; if there are more than 3 trailing +/−1s, only the last 3 are treated as “special cases” and any others are coded as normal coefficients. There are 4 choices of look-up table to use for encoding coeff_{—token, described as Num-VLCO, Num-VLC1, Num-VLC2 and Num-FLC (}3 variable-length code tables and a fixed-length code). The choice of table depends on the number of non-zero coefficients in upper and left-hand previously coded blocks Nu and NL.

Step 2: Encode the Sign of Each T1.

For each T1 (trailing +/−1) signalled by coeff_token, a single bit encodes the sign (0=+, 1=−). These are encoded in reverse order, starting with the highest-frequency T1.

Step 3: Encode the Levels of the Remaining Non-Zero Coefficients.

The level (sign and magnitude) of each remaining non-zero coefficient in the block is encoded in reverse order, starting with the highest frequency and working back towards the DC coefficient. The choice of VLC table to encode each level adapts depending on the magnitude of each successive coded level (context adaptive). There are 7 VLC tables to choose from, Level_VLC0 to Level_VLC6. Level_VLC0 is biased towards lower magnitudes; Level_VLC1 is biased towards slightly higher magnitudes and so on.

Step 4: Encode the Total Number of Zeros before the Last Coefficient.

TotalZeros is the sum of all zeros preceding the highest non-zero coefficient in the reordered array. This is coded with a VLC. The reason for sending a separate VLC to indicate TotalZeros is that many blocks contain a number of non-zero coefficients at the start of the array and (as will be seen later) this approach means that zero-runs at the start of the array need not be encoded.

Step 5: Encode Each Run of Zeros.

The number of zeros preceding each non-zero coefficient (run_before) is encoded in reverse order. A run_before parameter is encoded for each non-zero coefficient, starting with the highest frequency.

TABLE 7
Detail profile for CAVLC decoding

| | | | | | | Total of | |
|---|---|---|---|---|---|---|---|
| | | | | | | residual | Other part of |
| | | | | | | data | entropy |
| sequence | Step 1 | Step 3 | Step 4 | Step 5 | Others | decoding | decoding |
| flowergarden | 23.4% | 1.5% | 7.1% | 12.9% | 6.0% | 50.9% | 7.1% |
| foreman | 15.5% | 0.3% | 3.8% | 3.2% | 3.4% | 26.2% | 7.6% |
| tempete | 23.9% | 1.0% | 6.4% | 9.0% | 5.4% | 45.7% | 7.3% |
| mobile | 26.6% | 1.2% | 7.3% | 11.5% | 6.5% | 53.1% | 6.8% |
| highway | 16.3% | 0.3% | 3.7% | 2.6% | 4.5% | 27.4% | 7.7% |
| paris | 13.8% | 0.8% | 3.7% | 6.0% | 3.6% | 27.9% | 7.9% |

Time profile of CAVLC decoding for the six testing bitstream is displayed in table 7. The percentage in the table is obtained by dividing the corresponding decoding time of each step by the total decoding time. Column 2 is the percentage for step 1, column 3 is the percentage for step 3, column 4 is the percentage for step 4, and column 5 is the percentage for step 5. Column 6 is the percentage for other functions (including step 2 and function calling) of residual data decoding module. Column 7 denotes the percentage of total residual data decoding compared with total decoding time. The last column denote the entropy decoding percentage for bitstream other than residual data.

From table 7 it can be seen that step 1, 4 and 5 are the most time consuming steps. These three steps have the same characteristic of tentatively looking up tables. Reference code use same lentab and codtab tables for both encoding and decoding. Encoder knows each coordinate in advance and takes out a value from the table. For decoder, things are quite different. Decoder must try to find out both x and y coordinates while length is not known. So it is very tentative for decoder to try for each length. Thus a key factor for optimization of decoding residual data is to reform the tables for each step. The target of table changes is to minimize table lookup times and bitstream reading times. Program flow should be changed according to the table. The reformed table for readSyntaxElement_Run (step 5) is shown in table 5. The design principle for the reformed table is as follows: put delta len in lentab_codtab_Run[vlcnum][jj][0], look up table using the value obtained from len, look up operation is finished as long as temp=lentab_codtab_Run[vlcnum][jj][value+1] is not zero. Run equal to temp-1. Thus we finished the procedure of reading run by reading bitstream only once.

TABLE 8
original and reformed table for readSyntaxElement_Run

| Original table | Reformed table |
|---|---|
| int lentab[TOTRUN_NUM][16] = | static char lentab_codtab_Run[7][9][9] |
| { | = |
| {1,1}, | { |
| {1,2,2}, | { |
| {2,2,2,2}, | { 1, 2, 1, 0, 0, 0, 0, 0, 0}, |
| {2,2,2,3,3}, | }, |
| {2,2,3,3,3,3}, | { |
| {2,3,3,3,3,3,3}, | { 1,21, 1, 0, 0, 0, 0, 0, 0}, |
| {3,3,3,3,3,3,3,4,5,6,7,8,9,10,11}, | { 1, 3, 2, 0, 0, 0, 0, 0, 0}, |
| }; | }, |
| | { |
| int codtab[TOTRUN_NUM][16] = | { 2, 4, 3, 2, 1, 0, 0, 0, 0}, |
| { | }, |
| {1,0}, | { |
| {1,1,0}, | { 2,21, 3, 2, 1, 0, 0, 0, 0}, |
| {3,2,1,0}, | { 1, 5, 4, 0, 0, 0, 0, 0, 0}, |
| {3,2,1,1,0}, | }, |
| {3,2,3,2,1,0}, | { |
| {3,0,1,3,2,5,4}, | { 2,21, 0, 2, 1, 0, 0, 0, 0}, |
| {7,6,5,4,3,2,1,1,1,1,1,1,1,1,1}, | { 1, 6, 5, 4, 3, 0, 0, 0, 0}, |
| }; | }, |
| | { |
| | { 2,21, 0, 0, 1, 0, 0, 0, 0}, |
| | { 1, 2, 3, 5, 4, 7, 6, 0, 0} |
| | }, |
| | { |
| | { 3,21, 7, 6, 5, 4, 3, 2, 1}, |
| | { 1,21, 8, 0, 0, 0, 0, 0, 0}, |
| | { 1,21, 9, 0, 0, 0, 0, 0, 0}, |
| | { 1,21,10, 0, 0, 0, 0, 0, 0}, |
| | { 1,21,11, 0, 0, 0, 0, 0, 0}, |
| | { 1,21,12, 0, 0, 0, 0, 0, 0}, |
| | { 1,21,13, 0, 0, 0, 0, 0, 0}, |
| | { 1,21,14, 0, 0, 0, 0, 0, 0}, |
| | { 1,21,15, 0, 0, 0, 0, 0, 0}, |
| | } |
| | }; |

Note:
Each table may have special cases for processing, such as the value 21 in above table.

In addition to the above described optimization processes, loop unrolling, loop distribution and loop interchange and cache optimization can be used.

Table 9 shows time profile for the kernel modules of this optimized decoder. Results were averaged on 10 times for every sequence.

Table 9 shows the speed-up for the kernel modules in the optimized main profile decoder compared with non-optimized main profile decoder. It is clear from the table that the time used for motion compensation and inverse integer transform and residual data reading modules are dramatically minimized as a result of optimization implementation. Deblock module has minor improvement of about two times faster. Implementation of the above described optimization processes result in seven times improvement in the optimized H.264 main profile decoder compared with the reference decoder.

TABLE 9
Kernel module speed-up

| | | | | Reading | |
|---|---|---|---|---|---|
| | Motion | | | residual | Decoder |
| Sequence | Compensation | IDCT | deblock | data | fps |
| flowergarden | 8.97X | 4.30X | 1.90X | 10.17X | 6.87X |
| foreman | 8.53X | 8.22X | 1.80X | 9.83X | 6.34X |
| tempete | 8.33X | 4.40X | 1.68X | 10.27X | 6.34X |
| mobile | 7.73X | 3.36X | 1.70X | 10.63X | 6.57X |
| highway | 9.31X | 9.96X | 2.14X | 11.24X | 6.97X |
| paris | 10.78X | 12.46X | 2.32X | 9.10X | 7.63X |

Table 10 shows the time distribution of Optimized Main profile H264 decoder in percentage. The percentage of the motion compensation and inverse integer transform and entropy decoding modules are minimized. At the same time, deblocking filter now has a much larger impact in the H.264 decoder.

TABLE 10
Time Distribution of optimized MP decoder

| | Motion | | | Reading | | |
|---|---|---|---|---|---|---|
| | Com- | | | residual | Decoding | Decoder |
| Sequence | pensation | IDCT | deblock | data | time (s) | fps |
| flowergarden | 19.0% | 8.0% | 15.9% | 34.4% | 1.655 | 151.102 |
| foreman | 31.5% | 5.4% | 21.8% | 16.9% | 1.528 | 196.289 |
| tempete | 22.9% | 7.2% | 19.2% | 28.2% | 1.918 | 135.553 |
| mobile | 21.5% | 8.2% | 17.4% | 32.8% | 2.455 | 122.210 |
| highway | 28.9% | 6.3% | 19.5% | 17.0% | 1.096 | 273.751 |
| paris | 24.5% | 5.7% | 19.1% | 23.4% | 0.925 | 324.451 |

Decoder Implemented on DSP

According to an illustrative embodiment of the invention, decode modules are implemented on a DSP, such as a Blackfin BF533 or BF561. Examplary decode modules on BF533 include:
(1) H264 bitstream decoding
(2) synchronization of audio and video
(3) PPI interrupt function for displaying moving video or interface
(4) SPI interrupt function for receiving video bitstream and interface commands from CF5249
(5) module executing interface command, such as display text information, xor rectangular and display icon etc.
(6) OSD module for pasting fast forward, fast backward, pause and mute icon.
(7) auto update DSP program
(8) display rolling info
(9) display subtitle
(10) multi decoder control

H264 Bitstream Decoding

Utilizing CACHE

To better utilize the DSP memory, decoded frames are stored in SDRAM. That is to say, reference frames are in SDRAM. But access speed of SDRAM is much slower compared with L1. We use 16 KB (0×FF804000−0×FF807FFF) L1_DATA_A space as CACHE, L1_SCRATCH as stack. Thus 48 KB L1 space is left for storage of all critical decoding variables.

Utilizing MDMA

Although CACHE is used, we should also try to avoid reading and writing SDRAM directly. It is very efficient to decode the current macroblock slice in L1 and then MDMA this macroblock slice to SDRAM after it is totally decoded. By macroblock slice I mean one (16*720+8*360*2) image bar. BF533 has only two MDMAs, namely MDMAO and MDMA1. We use MDMA1 for this macroblock slice transfer. MDMAO is reserved for PPI display.

Assembly Optimizing

We can use standard C in Visual DSP++ and the complier with change our C code to assembly. For the fastest decoding speed we rewrite the C optimized code to assembly code according to the algorithm characteristic of each function. Video Pixel Operations and Parallel Instructions are good tricks.

Audio and Video Synchronization

According to a preferred embodiment, audio and video are decoded in separate DSPs, so the synchronization is a special case compared with single chip solution. The player run in CPU send both video and audio timestamps to BF533 and BF533 try to match the two timestamps by control the displaying time of each video frames. Thus the player should send a bit more video bitstream to BF533 for BF533 to decode in advance and display the corresponding video frame at the same time with audio.

PPI Interrupt Function

Video display is realized through PPI, one of BF533 external peripherals. The display frequency demanded by ITU 656 is 27 MHZ. External Bus Interface Unit of BF533 is compliant with the PC133 SDRAM standard. That is to say, if display buffer is in SDRAM, the decoding program will often interrupt display that we can never get clear image as long as decoder is working.

We use two 1716 bytes line buffer in L1 space. Thus the display strategy is as follows: PPI always read data from these two line buffer using DMAO. After reading over each line buffer, one interrupt is generated. In the PPI interrupt function, we prepare the next ITU 656 line using MDMA0.

The advantage of this line buffer display strategy is that the bandwidth of MDMA0 from SDRAM to L!1 is much higher than SDRAM to PPI. Thus EBIU bandwidth could be maximally used by H264 decoder.

SPI Interrupt Function

BF533 receive data from CF5249 through SPI controller. Real data is followed by a 24-bytes header. In SPI interrupt function, we check the 24-bytes header to know data type and then set DMA5 to receive next chunk of data by setting its receive address. Since data is received by DMA to SDRAM, so the core may read wrong data from CACHE. So we always spare al least 32 bytes (CACHE line size) to store next chunk of data.

Interface Module

This module realize the following functions: update rectangular, display large and small images, display English or Chinese text, display input box, xor rectangle, change the color of a rectangle, fill a specified region, change the color of text in a rectangle, display icon, draw straight line, etc.

When realizing these interface command, the current interface image is displaying. Since core has priority over MDMA0 and MDMA0 has priority over MDMA1, we use MDMA1 to operate the image memory to avoid green or white lines on TV screen. That is to say, we use MDMA1 the corresponding line to be modified to L1 and compute new value in L1 and then MDMA1 the modified line out to its original storage place.

Multi Decoder Control

BF533 has 64 KB SRAM and 16 KB SRAM/CACHE in L1, which is sufficient for storing instructions for one codec. When there is multiple decoding, instruction CACHE is used. Another choice is to use memory overlay. Overlay manager will DMA the corresponding function into L1 when needed. Memory overlay is mostly used in chips without CACHE. It is not a good choice for BF533 since memory overlay is not as good as CACHE.

We use a pure DMA method to switch the next being used codec into L1. We store instruction code and data blocks for each specific codec in SDRAM in advance. When one codec is needed, the shell program DMA the corresponding instruction and data into L1. All codec should have the same main function calling address and interrupt calling address by using RESOLVE in LDF files. Different decoders should use the same LDF file and shell program. Thus each decoder could be debugged separately.

H.264 Encoder Optimization

For H264 encoder optimization, JM61e is used as the reference coder. Non-main profile sections are eliminated to arrive at a main profile encoder. Further speed improvement can be realized by optimizing processes such as RDO (Rate Distortion Optimization) algorithm, fast motion search algorithm, and bitrate control algorithm. In addition, a fast ‘SKIP’ macroblock detect is used. Still further, encoder speed is improved by using MMX/SSE/SSE2 instructions. For HTT (Hyper Thread Technology) and multi-CPU computers, ‘omp parallel sections’ is used for parallel encoding.

Improved RDO Algorithm

According to a preferred embodiment of the present invention, a Rate Distortion Optimization (RDO) process is employed. This minimizes the function D+L×R, where D and R denote distortion and bit rate respectively and L is the Lagrange multiplier, to select the best macroblock mode and MV. The procedure to encode one macroblock ^{S} in a I-, P- or B-frame in the high-complexity mode is summarized as follows.
a) Given the last decoded frames, Lagrange multipliers λ_{MODE} and λ_{MOTION}, and the macroblock quantisation parameter QP.
   L_{MODE}=0.85×2^{QP/3},
   L_{MOTION}=\sqrt{L_{MODE}};
b) Choose intra prediction modes for the INTRA 4×4 macroblock mode by minimizing
   J(s,c,IMODE|QP,λ_{MODE})=SSD(s,c,IMODE|QP)+λ_{MODE}·R(s,c,IMODE|QP)
   with
   IMODE∈{DC,HOR,VERT,DIAG,DAIG_RL,DAIG_LR}.
c) Determine the best Intral16×16 prediction mode by choosing the mode that results in the minimum SATD.
d) For each 8×8 sub-partition,
Perform motion estimation and reference frame selection by minimizing
SSD+L×Rate(MV,REF)
B frames: Choose prediction direction by minimizing
SSD+L×Rate(MV(PDIR),REF(PDIR))
Determine the coding mode of the 8×8 sub-partition using the rate-constrained mode decision, i.e. minimize
SSD+L×Rate(MV,REF,Luma-Coeff,block 8×8 mode)
Here the SSD calculation is based on the reconstructed signal after DCT, quantization, and IDCT.

$$SSD ( s , c , MODE \vert QP ) = {\sum }_{x = 1 , y = 1}^{16 , 16} {( {s}_{Y} [ x , y ] - {c}_{Y} [ x , y , MODE \text{\vert} QP ] )}^{2} + {\sum }_{x = 1 , y = 1}^{8 , 8} {( {s}_{U} [ x , y ] - {c}_{U} [ x , y , MODE \text{\vert} QP ] )}^{2} + {\sum }_{x = 1 , y = 1}^{8 , 8} {( {s}_{V} [ x , y ] - {c}_{V} [ x , y , MODE \text{\vert} QP ] )}^{2}$$
e) Perform motion estimation and reference frame selection for 16×16, 16×8, and 8×16 modes by minimizing
   J(REF,m(REF)|L_{MOTION})=SA(T)D(s,c(REF,m(REF)))+L_{MOTION}·(R(m(REF)−p(REF))+R(REF))
   for each reference frame and motion vector of a possible macroblock mode.
f) B frames: Determine prediction direction by minimizing
   J(PDIR|L_{MOTION})=SATD(s,c(PDIR,m(PDIR)))+L_{MOTION}·(R(m(PDIR)−p(PDIR))+R(REF(PDIR)))
g) Choose the macroblock prediction mode by minimizing
J(s,c,MODE|QP,L_{MODE})=SSD(s,c,MODE|QP)+L_{MODE}·R(s,c,MODE|QP)
given QP and L_{mode} when varying MODE. MODE indicates a mode out of the set of potential macroblock modes:

$$I frame \text{:} MODE ∈ \{ INTRA 4 \times 4 , INTRA 16 \times 16 \} , \\ P frame \text{:} MODE ∈ \{ \begin{matrix}INTRA 4 \times 4 , INTRA 16 \times 16 , SKIP , \\ 16 \times 16 , 16 \times 8 , 8 \times 16 , 8 \times 8 ,\end{matrix} \} , \\ B frame \text{:} MODE ∈ \{ \begin{matrix}INTRA 4 \times 4 , INTRA 16 \times 16 , DIRECT , \\ 16 \times 16 , 16 \times 8 , 8 \times 16 , 8 \times 8\end{matrix} \} .$$

The computation of J(s,c,SKIP|QP,L_{mode}) and J(s,c,DIRECT|QP,L_{mode}) is simple. The costs for the other macroblock modes are computed using the intra prediction modes or motion vectors and reference frames.

To further improve RDO algorithm speed, processing continues as follows.
a) Given the last decoded frames, Lagrange multipliers λ_{MODE} and λ_{MOTION}, and the macroblock quantisation parameter QP.
   L_{MODE}=0.85×2^{QP/3},
   L_{MOTION}=\sqrt{L_{MODE}},
b) If current frame is I frame, jump to step h);
c) Detect whether the current macroblock could be encoded using ‘SKIP’ mode. If so, the procedure is terminated.
d) Perform motion estimation and reference frame selection for 16×16, 16×8, and 8×16 modes by minimizing
   J(REF,m(REF)|L_{MOTION})=SA(T)D(s,c(REF,m(REF)))+L_{MOTION·(}R(m(REF)−p(REF))+R(REF))
e) If the cost of 8×8 mode is minimal in step d), then go to step f, else go to step g);
f) For each 8×8 sub-partition,
   Perform motion estimation and reference frame selection by minimizing
   SA(T)D+L×Rate(MV,REF)
   Determine the coding mode of the 8×8 sub-partition using the rate-constrained mode decision, i.e. minimize
   SSD+L×Rate(MV,REF,Luma-Coeff,block 8×8 mode)
g) If J is greater than a predefined threshold (such as 128), then jump to step h) for intra detection, else jump to step j);
h) Choose intra prediction modes for the INTRA 4×4 macroblock mode by minimizing
   J(s,c,IMODE|QP,λ_{MODE})=SSD(s,c,IMODE|QP)+λ_{MODE}·R(s,c,IMODE|QP)
   with
   IMODE∈{DC,HOR,VERT,DIAG,DIAG_RL,DIAG_LR}.
i) Determine the best Intral16×16 prediction mode by choosing the mode that results in the minimum SATD.
j) The last step: Choose the macroblock prediction mode by minimizing
   J(s,c,MODE|QP,L_{MODE})=SSD(s,c,MODE|QP)+L_{MODE}·R(s,c,MODE|QP).

The improvement in speed of the above RDO is realized from the following processes:
1) For macroblock in P frame, ‘SKIP’ mode is first checked, (i.e. if take predicted motion vector as the motion vector of 16×16, check whether CBP is 0. The fast algorithm for ‘SKIP’ mode detection is depicted in next section.). If ‘SKIP’ mode is tested OK, the RDO procedure is terminated.
2) After ‘SKIP’ mode detection, check large blocks of 16×16, 16×8, 8×16 and 8×8,. Only when
8×8 is the best for the comparison of the four block types, there is need to check blocks sizes below 8×8.
3) If the result of inter detection is smaller than a predefined threshold, there is no need to further detect intra modes.
4) For further improving encoding speed, SAD can be used instead of SATD in the part of SA(T)D.

Fast ‘SKIP’ Mode Detection Method Algorithm

In general, bitstream of intra coded macroblock has the following information: macroblock type, luma prediction mode, chroma prediction mode, delta QP, CBP, and residual data. Bitstream of inter coded macroblock has the information of macroblock type, reference frame index, delta motion vector compared with predicted motion vector, delta QP, CBP and residual data.

Skipped macroblock is a macroblock for which no data is coded other than an indication that the macroblock is to be decoded as “skipped”. Macroblocks in P and B frames are allowed to use skipped mode. The advantage of skipped macroblock is that only macroblock type is transmitted, hence bitstream is sparingly used.

For a macroblock in P frame to be coded as skipped mode, the following five conditions must be satisfied:

1 ) the current frame is P frame;

2) the best encoding block type for the current macroblock is 16×16;

3) CBP of current macroblock is zero;

4) the reference frame referenced by the current frame has index 0 in reference frame list;

5) the best motion vector for the current macroblock is predicted motion vector of 16×16 block.

According to a preferred embodiment of the invention, a fast ‘SKIP’ mode detection method includes:

Step 1: compute the predicted motion vector of 16×16 block

Encoding a motion vector for each partition can take a significant number of bits, especially if small partition sizes are chosen. Motion vectors for neighbouring partitions are often highly correlated and so each motion vector is predicted from vectors of nearby, previously coded partitions. A predicted vector, MVp, is formed based on previously calculated motion vectors. MVD, the difference between the current vector and the predicted vector, is encoded and transmitted. The method of forming the prediction MVp depends on the motion compensation partition size and on the availability of nearby vectors and can be summarised as follows (for macroblocks in P-slices).

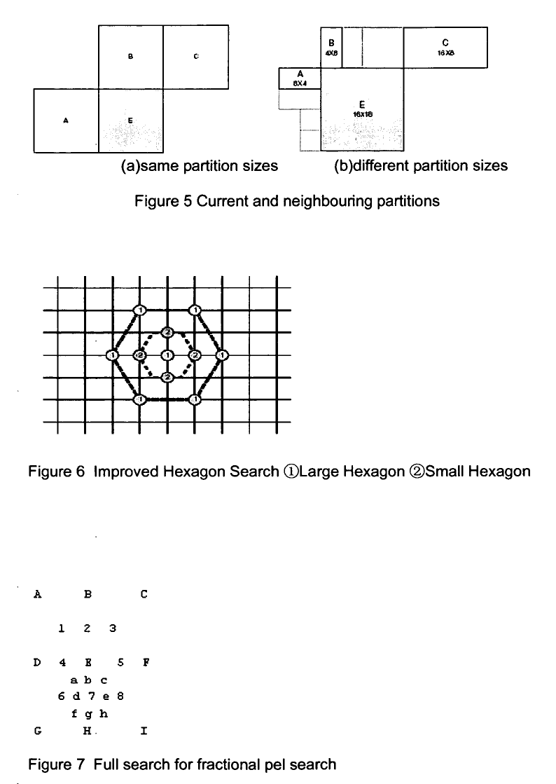

Let E be the current macroblock, macroblock partition or sub-partition; let A be the partition or subpartition immediately to the left of E; let B be the partition or sub-partition immediately above E; let C be the partition or sub-partition above and to the right of E. If there is more than one partition immediately to the left of E, the topmost of these partitions is chosen as A. If there is more than one partition immediately above E, the leftmost of these is chosen as B. FIG. 5(a) illustrates the choice of neighbouring partitions when all the partitions have the same size (16×16 in this case); FIG. 5(b) shows an example of the choice of prediction partitions when the neighboring partitions have different sizes from the current partition E.

For skipped macroblocks: a 16×16 vector MVp is generated as in case (1) above (i.e. as if the block were encoded in 16×16 Inter mode). If one or more of the previously transmitted blocks shown in the Figure are not available (e.g. if it is outside the current picture or slice), the choice of MVp is modified accordingly.

Step 2: Compute the CBP of Y Component, and Check Whether it is Zero

Take the predicted motion vector MVp as current motion vector, and compute the predicted value of Y component, then by subtraction of original pixel and predicted pixel we get residual data. Do DCT transform for the sixteen 4×4 residual blocks and then quantize the residual block. If any 4×4 block has non-zero coefficient, the detection is terminated. Here, an ETAL (Early Termination Algorithm for Luma) algorithm for detecting whether one 4×4 block has non-zero coefficient can be used.

H.264 use 4×4 integer transform, the transform formula is as follows:

$$\begin{matrix}Y = {C}_{f} {XC}_{f}^{T} ⊗ {E}_{f} \\ = ( [ \begin{matrix}1 & 1 & 1 & 1 \\ 2 & 1 & - 1 & - 2 \\ 1 & - 1 & - 1 & 1 \\ 1 & - 2 & 2 & - 1\end{matrix} ] [ \begin{matrix} & & & \\ & X & & \\ & & & \\ & & & \end{matrix} ] [ \begin{matrix}1 & 2 & 1 & 1 \\ 1 & 1 & - 1 & - 2 \\ 1 & - 1 & - 1 & 2 \\ 1 & - 2 & 1 & - 1\end{matrix} ] ) ⊗ \\ [ \begin{matrix}{a}^{2} & ab \text{/} 2 & {a}^{2} & ab \text{/} 2 \\ ab \text{/} 2 & {b}^{2} \text{/} 4 & ab \text{/} 2 & {b}^{2} \text{/} 4 \\ {a}^{2} & ab \text{/} 2 & {a}^{2} & ab \text{/} 2 \\ ab \text{/} 2 & {b}^{2} / 4 & ab \text{/} 2 & {b}^{2} \text{/} 4\end{matrix} ]\end{matrix}$$

Where CXC^{T} is a “core” 2-D transform. E is a matrix of scaling factors and the symbol \hat{×} indicates that each element of CXC^{T} is multiplied by the scaling factor in the same position in matrix E (scalar multiplication rather than matrix multiplication).

The basic forward quantizer operation in H264 is as follows:
Zᵢⱼ=round(Yᵢⱼ /Qstep)
where Yᵢⱼ. is a coefficient of the transform described above, Qstep is a quantizer step size and Zᵢⱼ is a quantized coefficient. A total of 52 values of Qstep are supported by the standard and these are indexed by a Quantization Parameter, QP. The wide range of quantizer step sizes makes it possible for an encoder to accurately and flexibly control the trade-off between bit rate and quality.

It can be assumed that if the DC value of transform coefficient is zero, then all other AC coefficients are zero. For a 4×4 block, the quantized DC value is:

$$DC = {\sum }_{x = 0}^{3} {\sum }_{y = 0}^{3} f ( x , y ) / ( ( {2}^{qbits} - f ) / QE [ {q}_{rem} ] [ 0 ] [ 0 ] )$$

Therefore if the following formula is satisfied, the quantized DC value would be zero.

$$\vert {\sum }_{x = 0}^{3} {\sum }_{y = 0}^{3} f ( x , y ) \vert < ( ( {2}^{qbits} - f ) / QE [ {q}_{rem} ] [ 0 ] [ 0 ] )$$

Where qbits=15+QP/6, pᵣₑₘ32 QP %6, f=(1<<qbits)/6, QE is the defined quantization coefficient table and QP is the input quantization parameter.

Step 3: Compute the CBP of U Component, and Check Whether it is Zero

First compute the predicted value of U component, then get the residual data of size 8×8. Do DCT transform for the four 4×4 block DCT, the chroma DC coefficients constitute 2×2 array W_{D}. This 2×2 chroma DC coefficients array should have Hadamard transform by the following equation:

$${Y}_{D} = [ \begin{matrix}1 & 1 \\ 1 & - 1\end{matrix} ] [ \begin{matrix}{W}_{D} & \\ & \end{matrix} ] [ \begin{matrix}1 & 1 \\ 1 & - 1\end{matrix} ]$$

The CBP of U component depends on the quantized coefficients of Y_{D} and the quantized non-DC coefficients of each 4×4 block. As long as one quantized coefficient is not zero, the CBP of U component is not zero and the detection should be terminated. Here ETAC (Early Termination Algorithm for Chroma) algorithm can be used for detecting whether one 8×8 chroma block has non-zero coefficient.

Since array W_{D} has all the DC components of 8×8 block, the CBP of component U is zero as long as quantized coefficients of Y_{D} are all zero.

The computation formulas for the four elements of W_{D} are:

$$\begin{matrix}{W}_{D } ( 0 , 0 ) = {\sum }_{y = 0}^{3} {\sum }_{x = 0}^{3} f ( x , y ) , \\ {W}_{D } ( 0 , 1 ) = {\sum }_{y = 0}^{3} {\sum }_{x = 4}^{7} f ( x , y ) , \\ {W}_{D } ( 1 , 0 ) = {\sum }_{y = 4}^{7} {\sum }_{x = 0}^{3} f ( x , y ) , \\ {W}_{D } ( 1 , 1 ) = {\sum }_{y = 4}^{7} {\sum }_{x = 4}^{7} f ( x , y ) .\end{matrix}$$

YD is computed as follows:
Y_{D}(0,0)=W_{D}(0,0)+W_{D}(0,1)+W_{D}(1,0)+W_{D}(1,1),
Y_{D}(1,0)=W_{D}(0,0)−W_{D}(0,1)+W_{D}(1,0)−W_{D}(1,1),
Y_{D}(0,1)=W_{D}(0,0)+W_{D}(0,1)−W_{D}(1,0)−W_{D}(1,1),
Y_{D}(1,1)=W_{D}(0,0)−W_{D}(0,1)−W_{D}(1,0)+W_{D}(1,1).

The quantization formula for each element of YD is:
(|Y_{D}(i,j)|×QE[qᵣₑₘ][0][0]+2×f)>>(qbits+1)

Hence CBP of U component is zero as long as the following function is satisfied.
|Y_{D}(i,j)<((2^{(qbits+1)}−2×f)/QE[qᵣₑₘ][0][0])
Where qbits=15+QP_SCALE_CR[QP]/6 . qᵣₑₘ=QP_SCALE_CR[QP]%6, f=(1<<qbits)/6, QE is the defined quantization coefficient table, QP is the input quantization parameter and QP_SCALE_CR is a constant table.

Step 4: Compute the CBP of V Component, and Check Whether it is Zero.

This step is similar to step 3. First compute the predicted value of V component, then get the residual data of size 8×8, finally test whether CBP is zero using ETAC method.

3. Fast Motion Search Algorithm

Similar to former video standards such as H.261, MPEG-1, MPEG-2, H.263, and MPEG-4, H.264 is also based on hybrid coding framework, inside which motion estimation is the most important part in exploiting the high temporal redundancy between successive frames and is also the most time consuming part in the hybrid coding framework. Specifically multi prediction modes, multi reference frames, and higher motion vector resolution are adopted in H.264 to achieve more accurate prediction and higher compression efficiency. As a result, the complexity and computation load of motion estimation increase greatly in H.264. It is seen that motion estimation can consume 60% (1 reference frame) to 80% (5 reference frames) of the total encoding time of the H.264 codec and much higher proportion can be obtained if RD optimization or some other tools is invalid and larger search range (such as 48 or 64) is used.

Generally motion estimation is conducted into two steps: first is integer pel motion estimation, and the second is fractional pel motion estimation around the position obtained by the integer pel motion estimation (we name it the best integer pel position). For fractional pel motion estimation, ½-pel accuracy is frequently used (H.263, MPEG-1, MPEG-2, MPEG-4), higher resolution motion vector are adopted recently in MPEG-4 and JVT to achieve more accurate motion description and higher compression efficiency.

Algorithms on fast motion estimation are always hot research spot, especially fast integer pel motion estimation has achieved much more attention because traditional fractional pel motion estimation (such as ½-pel) only take a very few proportion in the computation load of whole motion estimation. Many fast integer block-matching algorithms have been focused on the search strategies with different steps and search patterns in order to reduce the computation complexity and maintain the video quality at the same time. These typical fast block matching algorithms include three step search (TSS) 2-D logarithmic search, Four step search (FSS), HEXBS(Hexagon-Based Search), etc.

Based on the above former algorithms and the specific characteristic of H264 motion search, an improved Hexagon Search process is employed for integer pel motion estimation in H.264. Ths process decreases integer motion search points, and computation load of fractional pel motion estimation is decreased.

Step 1: The median value of the adjacent blocks on the left, top, and top-right (or top-left) of the current block is used to predict the motion vector of the current block
pred_{—}mv=median(Mv_A,Mv_B,Mv_C)
Take this predicted motion vector (Pred_x, Pred_y) as the best motion vector and compute rate-distortion cost using this motion vector.

Step 2: Compute rate-distortion cost for (0, 0) vector. The prediction with the minimum cost is taken as best start searching position.

Step 3: If current block is 16×16, compute rate-distortion cost for Mv_A, Mv_B, and Mv_C and then compare with best start searching position. The prediction with the minimum cost is taken as best start searching position.

Step 4: If current block is not 1 6×16, compute rate-distortion cost for motion vector of the up layer block (for example, mode 5 or 6 is the up layer of mode 7, and mode 4 is the up layer of mode 5 or 6, etc.). The prediction with the minimum cost is taken as best start searching position.

Step 5: Take the best start searching position as center, search the six position around it according to Large Hexagon in FIG. 6. If the central point has minimum cost, then terminate this step; or else take the minimum cost point as the next search center and execute large hexagon search again, until the minimum cost point is central point. The maximum large hexagon search times could be limited, such as 16.

Step 6: Take the best position of Step 5 as center, search the four position around it according to Small Hexagon in FIG. 3. If the central point has minimum cost, then terminate this step; or else take the minimum cost point as the next search center and execute small hexagon search again, until the minimum cost point is central point.

Step 7: Integer pel search terminated, the current best motion vector is the final choice. For fractional pel motion estimation, a so called fractional pel search window which is an area bounded by eight neighbor integer pels positions around the best integer pel position is examined. In generation of these fractional pel positions, a 6 tap filter is used to produce the ½-pel positions, ¼-pel positions is produced by linear interpolation.

FIG. 7 shows the typical Hierarchical Fractional Pel Search algorithm provided in JM test model. The HFPS is described by the following 3 steps:

Step 1. Check the eight ½-pel positions (1-8 points) around the best integer pel position to find the best ½-pel motion vector;

Step 2. Check the eight ¼-pel positions (a-h points) around the best ½-pel position to find the best ¼-pel motion vector;

Step 3. Select the motion vector and block-size pattern, which produces the lowest rate-distortion cost.

The diamond search pattern is employed in fast fractional pel search.

Step 1. Take the best position of interger pel as center point, search the four diamond position around it.

Step 2. If the MBD (Minimum Block Distortion) point is located at the center, go to step 3; otherwise choose the MBD point in this step as the center of next search, then iterate this step;

Step 3. Choose the MBD point as the motion vector.

Bitrate Control

An encoder employs rate control as a way to regulate varying bit rate characteristics of the coded bitstream to produce high quality decoded frame at a given target bit rate. The rate control for JVT is more difficult than those for other standards. This is because the quantization parameters are used in both rate control algorithm and rate distortion optimization (RDO), which resulted in the following chicken and egg dilemma when the rate control is studied: to perform RDO for macroblocks (MBs) in the current frame, a quantization parameter should be first determined for each MB by using the mean absolute difference (MAD) of current frame or MB. However, the MAD of current frame or MB is only available after the RDO.

Addition processes can be employed to: restrict maximum and minimum QP; if the video image is bright or includes a large amount of movement for a long time, clear R (which denotes bitrate profit and loss) for later dark or quiet scene; and If the video image is dark or quiet for a long time, clear R (which denotes bitrate profit and loss) for later bright or severely moving scene.

Still further optimization include: the use of MMX, SSE, and SSE2 instructions; avoiding access large global arrays by using small temporary buffer and pointers; and

Use omp parallel instruction, for examples:

```
#pragma omp parallel sections
{
    #pragma omp section
        master_thread20(&images_private_master);
    #pragma omp section
        slave_thread21(&images_private_slave1);
}
```

Having thus described exemplary embodiments of the present invention, it is to be understood that the invention defined by the appended claims is not to be limited by particular details set forth in the above description as many apparent variations thereof are possible without departing from the spirit or scope thereof as hereinafter claimed.

1. A method of decoding MPEG4 compliant coded signals, comprising:
disabling processing for non-main profile sections;
performing reference frame padding; and
performing adaptive motion compensation.

2. The method of claim 1, further including performing fast IDCT wherein an IDCT process is performed on profile signals but no IDCT is performed based on whether a 4×4 block may be all zero, or only DC transform coefficient is non-zero.

3. The method of claim 1, further including disabling non-main profile processing including error correction and redundant slices processing.

4. The method of claim 1, further including CAVLC encoding of residual data.

5. The method of claim 1, wherein reference frame padding comprises compensating for motion vectors extending beyond a reference frame by adding to at least the length and width of the reference frame.

6. The method of claim 1, wherein adaptive motion compensation includes original block size compensation processing for chroma up to block sizes of 16×16.

7. The method of claim 1, wherein disabling non-main profile slices include disabling SP and SI slices;

8. The method of claim 1, wherein processing parameters are set according to:
(1) single frame reference (NumberReferenceFrames=1);
(2) one slice in each frame (SliceMode=0);
(3) I frame interval is 100 (Intraperiod=100);
(4) quantization parameter is 25 (QPFirstFrame=QPRemainingFrame=25);
(5) not using Hadamard (UseHadamard=0);
(6) max search range is 16 (SearchRange=16);
(7) not using rate distortion optimization (RDOptimization=0);
(8) using all blocks types from 16×16 to 4×4 (InterSearchl16×16=1, InterSearchl16×8=1, InterSearch8×16=1, InterSearch8×8=1, InterSearch8×4=1, InterSearch4×8=1, InterSearch4×4=1);
(9) Inter pixels are used for Intra macroblock prediction (UseConstrainedIntraPred=0);
(10) POC mode is 0 (PicOrderCntType=0).
(11) Entropy coding method is 0, i.e. CAVLC (SymbolMode=0).

9. A method of encoding MPEG4 compliant data, comprising: performing Rate Distortion Optimization (RDO) algorithm, fast motion search algorithm, and bitrate control algorithm.

10. A method according to claim 9, further including use of MMX/SSE/SSE2 instructions.
